(19) United States
(12) Patent Application Publication
(10) Pub. No.: US 2009/0109067 A1
(43) Pub. Date: Apr. 30, 2009

(54) METHOD, APPARATUS, AND COMPUTER PROGRAM FOR TEXT INPUT

(75) Inventor: David Per BURSTROM, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/926,207

(22) Filed: Oct. 29, 2007

(51) Int. Cl. G06F 3/00

(52) U.S. Cl. 341/22

(57) ABSTRACT

A method for predictive text input is disclosed. The method comprises receiving a first key typing on a first key, wherein said first key is associated with a first symbol or set of symbols; receiving a second key typing on a second key while said first key is still pressed, wherein said second key is associated with a second symbol or set of symbols; determining words from a word list beginning with said first symbol or any of the symbols of said first set of symbols and being followed by said second symbol or any of the symbols of said second set of symbols; enabling selection among said determined words; and upon selection, inputting said selected word. An apparatus and a computer program for implementing the method are also disclosed.

### FIELD OF INVENTION

The present invention relates to a method for text input, an apparatus having text input capabilities, and a computer program for text input.

### BACKGROUND OF INVENTION

Input of text has been an issue ever since mechanical text input machines were introduced, such as typewriters. An example on an approach emanating from this time is the QWERTY-keyboard, which is still widely used for computer inputs. Miniaturizing of computers and other apparatuses having text input capabilities, such as mobile phones, personal digital assistants, digital cameras, media players, etc., has implied use of small keyboards which are not optimal to hand size of the user since size constraints of the apparatus would not allow this. Some of these miniaturized apparatuses also have a so-called ambiguous keyboard, i.e. each key is associated with several symbols. In those cases, the desired symbol can be typed by using multi-tapping, i.e. the user presses the key repeatedly until the desired symbol is reached. Another approach has been different predictive methods for text input, where for example a user presses a sequence of ambiguous keys, and a processor determines candidates that fit with the typed sequence. Different users have their favourites among these approaches, and many apparatuses provides selection among these input approaches. Therefore, there is considered to be a need for further approaches for text input, to be used as a favourite approach by some users, or in combination with other approaches by other users.

### SUMMARY

The present invention is based on the understanding that a user may prefer to do as few typings as possible to reach their intended input word. The present invention is also based on the understanding that a user may prefer a predictable behaviour of the apparatus when using an enhanced input method. Therefore, the inventor has found that a two-type-approach where word candidates are shown if and only if the first and the second typing overlap in time is appreciated. The inventor has further realized that this approach will intuitively distinguish input from other input approaches that may be used simultaneously, which otherwise normally requires change of settings through some kind of menu structure.

According to a first aspect of the present invention, there is provided a method for predictive text input comprising

receiving a first key typing on a first key, wherein said first key is associated with a first symbol or set of symbols;

receiving a second key typing on a second key while said first key is still pressed, wherein said second key is associated with a second symbol or set of symbols;

determining words from a word list beginning with said first symbol or any of the symbols of said first set of symbols and being followed by said second symbol or any of the symbols of said second set of symbols;

enabling selection among said determined words; and

upon selection, inputting said selected word.

The first and second set of symbols associated with said first and second keys, respectively, may be forming an ambiguous keyboard.

The determining of words may comprise ranking probability of said words from a word list beginning with said first symbol or any of the symbols of said first set of symbols and being followed by said second symbol or any of the symbols of said second set of symbols; and providing a presentation order of said determined words based on said ranking. The probability ranking may comprise determining frequency of said words for a selected language and/or determining frequency of said words in previous inputs.

According to a second aspect of the present invention, there is provided an apparatus having text input capabilities comprising a keyboard; a processor adapted to receive and process input from said keyboard; a memory arranged to be accessible by said processor and to hold a word list; and a display which is controlled by said processor, wherein said keyboard is enabled to receive a first key typing on a first key, wherein said first key is associated with a first symbol or set of symbols, and a second key typing on a second key while said first key is still pressed, wherein said second key is associated with a second symbol or set of symbols, said processor is arranged to determine words from said word list beginning with said first symbol or any of the symbols of said first set of symbols and being followed by said second symbol or any of the symbols of said second set of symbols, and said processor is further arranged to display said determined words on said display to enable selection among said determined words, and to receive a selection for input of a selected word.

The keyboard may be an ambiguous keyboard.

The processor may be further arranged to rank probability of said words from a word list beginning with said first symbol or any of the symbols of said first set of symbols and being followed by said second symbol or any of the symbols of said second set of symbols; and to provide a presentation order for said determined words based on said ranking. The memory may hold a meta data field for said words in said word list indicating probability of its corresponding word. The meta data may comprise relative frequency data of the word in its language, frequency data of the word in previous inputs, a weighting factor, or a grammar script, or any combination thereof.

According to a third aspect of the present invention, there is provided a computer readable medium comprising program code, which when executed by a processor is arranged to cause the processor to perform the method according to the first aspect.

The computer readable medium comprising the program code, which when executed by a processor may be arranged to cause the processor to perform receiving a first key typing on a first key, wherein said first key is associated with a first symbol or set of symbols; receiving a second key typing on a second key while said first key is still pressed, wherein said second key is associated with a second symbol or set of symbols; determining words from a word list beginning with said first symbol or any of the symbols of said first set of symbols and being followed by said second symbol or any of the symbols of said second set of symbols; enabling selection among said determined words; and upon selection, inputting said selected word.

The program code may, when executed by a processor, further be arranged to cause the processor to perform ranking probability of said words from a word list beginning with said first symbol or any of the symbols of said first set of symbols and being followed by said second symbol or any of the symbols of said second set of symbols; and providing a presentation order of said determined words based on said ranking.

In this context, the term “symbols” should be construed as elements for composing text, and may comprise letters, numbers, kanji, kana, strokes, logograms, characters, etc. whichever is used for different languages. Further, the term “word” should be construed as any unit of language, such as morpheme, phoneme, grapheme, semantic unit, expression, idiom, etc.

### BRIEF DESCRIPTION OF DRAWINGS

FIG. 1 is a flow chart illustrating a method according to an embodiment of the present invention.

FIG. 2 is a flow chart illustrating optional actions of a method according to an embodiment of the present invention.

FIG. 3 illustrates a computer readable medium according to an embodiment of the present invention.

FIG. 4 is a block diagram schematically illustrating an apparatus according to an embodiment of the present invention.

FIG. 5 illustrates an exemplary keyboard having keys uniquely associated to symbols.

FIG. 6 illustrates an exemplary ambiguous keyboard.

FIG. 7 illustrates another exemplary ambiguous keyboard.

FIGS. 8 to 11 illustrate exemplary apparatuses in which the invention is implementable.

### DETAILED DESCRIPTION

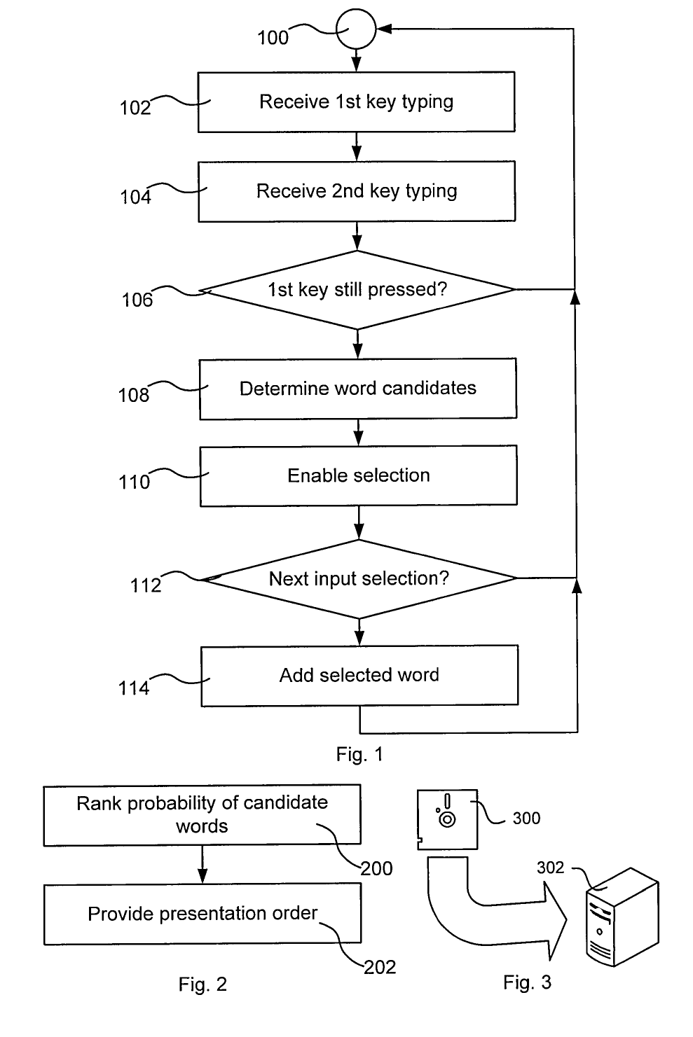

FIG. 1 is a flow chart illustrating a method according to an embodiment of the present invention. The circle 100 illustrates a general input procedure, for example normal typing, multi-tap input, or a predictive input method, which is used as a default input method at any time. In prior art methods, this default input method is normally chosen, if several methods are available, by the user by changing settings via a menu structure. The input method according to the present invention, on the other hand, is instantly activated as will be apparent from the detailed description below. The inventive method receives a first key typing in a first key typing reception step 102, and then a second key typing in a second key typing reception step 104. The method according to the present invention checks if the first and second typing are overlapping in time in a first key press checking step 206. In other words, it is checked whether the user presses the first key, and while still pressing the first key presses a second key. As will become clear from the description below, the user is thus able to instantly give an indication to the apparatus on which the input is performed that 1) this particular predictive input method is requested, 2) the first symbol of a desired word is associated with the first pressed key, and 3) the second symbol of the desired word is associated with the second pressed key. If it is found in the checking step 106 that there is no overlap in time, the default input method 100 will take care of the input. On the other hand, if it is found in the checking step 106 that there is an overlap in time between the first key typing and the second key typing, i.e. the keys are pressed simultaneously during some time of their respective pressing, the method continues to a word candidate determination step 108. In the word candidate determination step 108, it is determined, from one or more word lists, word candidates having a first symbol which corresponds to symbol(s) associated with the first key typing and having a second symbol which corresponds to symbol(s) associated with the second key typing. One or more word lists can be used, and if several word lists are used, the searching can be prioritized and/or limited depending on the number of hits, where some word lists may be considered more preferred than others. The prioritizing of word lists can for example be dependent on the present application, on receiver of a message if it is a message to be written, on a selected or detected language, on a certain state, time, date, or location, etc. There may for example be one word list with words related to a certain holiday which is prioritized during and/or slightly before this holiday, another word list associated with sailing which is prioritized when positioning means of the used apparatus determines proximity to the sea, further another word list with Danish words which is prioritized when connected to a Danish network operator with a communication apparatus, further another word list with chess terminology which is prioritized when sending messages to chess mates, etc. There are further approaches to providing a suitable list of word candidates when many hits are found, as will be described further with reference to FIG. 2 below.

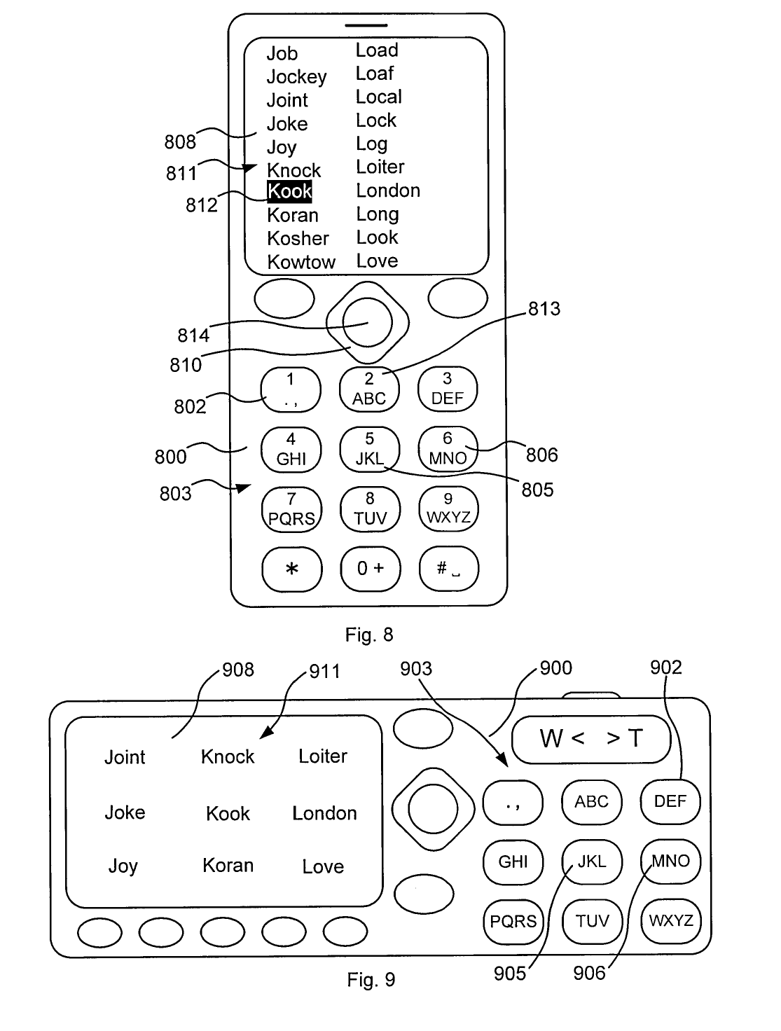

When the word candidates are determined in the word candidate determination step 108, the word candidates are provided such that a selection among the candidates can be performed in a selection enabling step 110. This can for example be displaying the candidates on a display and/or audio presentation of the words, e.g. by synthetic or recorded voice. The user is then able to select a desired word among the provided candidates, for example by means of navigation means, by pressing a key that is associated with a part on the display where the desired word is presented, by voice control, or by tapping the displayed word on a touch sensitive screen. It may happen that the word is not present in any word list, or that the simultaneous pressing of two keys was unintentional. Then the user just does not make any selection, which is detected in a selection checking step 112, and the process returns to the default input method, whereby the user can proceed with further inputs to form the desired text. Alternatively, it is possible for the user to proceed with further inputs to refine the candidate list. For example, the candidate list after the first and second key typing may give the candidate list illustrated in FIG. 8. The user then presses key 813, whereby the candidate list is limited to “Job”, “Jockey”, “Load”, “Loaf”, “Local”, and “Lock”, as the third input is associated to the third letter being “a”, “b”, or “c”. On the other hand, if the user selects any of the candidate words, as described above, and a selection is detected in the selection checking step 112, the process continues to a word adding step 114 where the selected word is added to the text input, e.g. the text message that is written, or the note to the photo just being shot. Then the process may return to the default input method again, where the inventive input method again can be instantly activated by simultaneous pressing of keys for input of next word.

FIG. 2 illustrates optional actions which can be used for any of the variants of the method described above. The optional actions relates to the issue when there is such a high number of candidates that it becomes difficult or at least less neat for the user to make the selection. Thus, the candidate words are ranked in an optional candidate word probability ranking step 200. The candidate words are ranked such that it is determined which is the most probable word among the candidates. The ranking can also determine the second, third, etc. most probable, but it should be noted that it is not necessary to make an exact ranking of all found candidates. The most important is to find the most probable, and maybe second and third best, and if processing capacity allows is, maybe a few further. It is more important that the determination is quick such that the result is provided to the user such that the predictive input method also is experienced as instant by the user. Therefore, probability data may be pre-stored together with the word list(s), for example as meta data. The meta data may comprise relative frequency of use in the actual language, updated frequency data made from previous inputs by the user, or other weighting factors. The meta data may also comprise a script or parameters to a grammar script adapted to check grammar to previous input words to be able to predict most probable form of the word. A presentation order of candidate words is provided in a presentation order provision step 202, where the order is based on the ranking that is performed in ranking step 200.

In the method variants demonstrated above, there is suggested that a typing of a key may be associated with a unique symbol, e.g. letter or number, or with several symbols. The latter case arises when an ambiguous keyboard is used. An ambiguous keyboard is a keyboard where a key is associated with several symbols, normally only a few to still make input feasible. In the context of the present invention, this increases the number of candidate words, and the number of candidates increases significantly if there are three or more symbols associated with each key. To give an example, consider a commonly used keyboard which is today used on most mobile phones where key number 7 is associated with letters “p”, “q”, “r”, and “s”, and key number 2 is associated with letters “a”, “b”, and “c”. For some languages, there are even more letters associated with the keys. Imagine a user pressing first key 7 and then key 2 while still pressing key 7. This gives an indication that candidate words are any words that starts with “pa”, “pb”, “pc”, “qa”, “qb”, “qc”, “rb” “rc”, “sa”, “sb”, “sc”. For many of these combinations there are not many words, if any, while for others, for example “sa” or “ra”, there is a multitude. Hence, the two-type approach works best for very few associated letters per key, but also work where there is a reasonable number of letters per key. In the latter example, it is especially advantageous to apply prioritizing of word lists and/or ranking of candidates. As indicated above, any type of symbols may be applicable for association with the keys and the inventive input method, such as letters, numbers, kanji, kana, strokes, etc.

The above demonstrated method and its demonstrated variants are particularly suitable for implementation for computer processing. The types of apparatuses in which the text input in question is feasible inherently comprise a computer or processor in which the processing can be performed. The methods and processes can be implemented as program code forming one or more computer programs, which when downloaded into the processors or computers of the entities or server, if the architecture is chosen as a client-server solution, respectively, arranges for performing the methods and processes. The program code can be stored on a computer readable medium 300, as schematically depicted in FIG. 3, which when downloaded and executed by a processor or computer 302 is arranged to cause the processor or computer to perform the actions described with reference to any of FIGS. 1 and 2. The computer and computer program can be arranged to execute the program code sequentially where actions of the any of the methods are performed stepwise, or be arranged to execute the program code on a real-time basis where actions of any of the methods are performed upon need and availability of data. The processing means, processor, or computer is preferably what normally is referred to as an embedded system. Thus, the depicted computer readable medium and computer in FIG. 3 should be construed to be for illustrative purposes only to provide understanding of the principle, and not to be construed as any direct illustration of the elements.

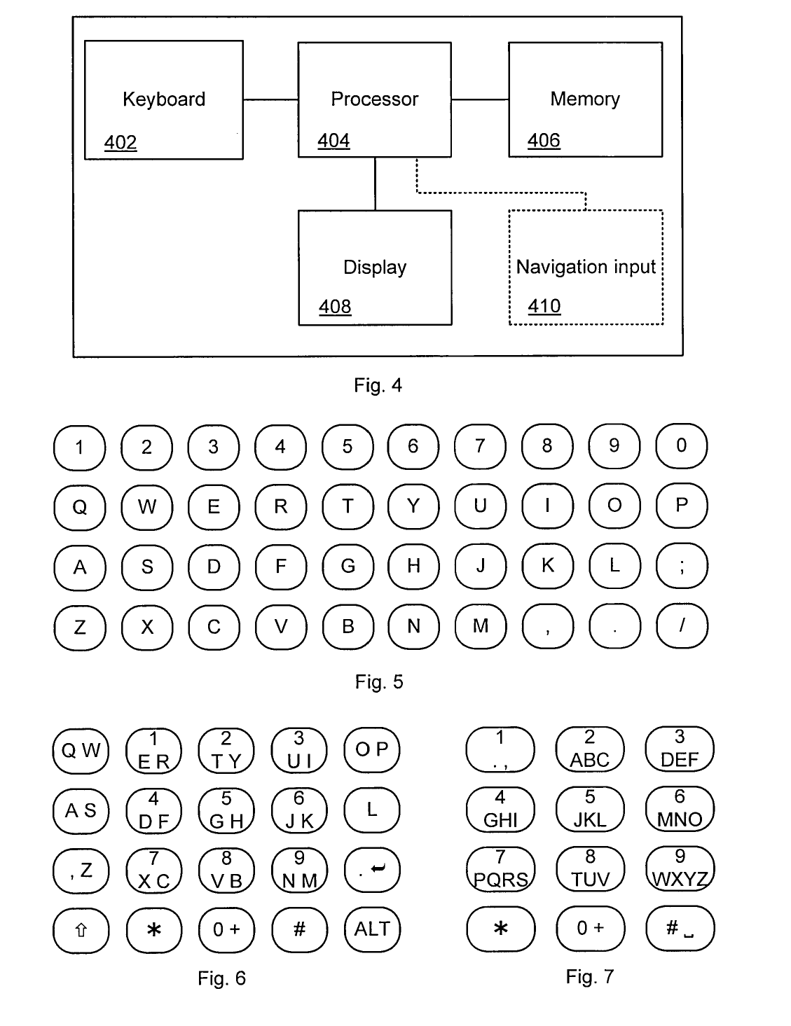

FIG. 4 is a block diagram schematically illustrating an apparatus 400 according to an embodiment of the present invention. The apparatus 400 comprises a keyboard 402, which is connected to a processor 404, which is adapted to receive inputs performed on the keyboard 402. The processor 404 processes the received inputs in accordance with applications and/or an operating system run on the processor 404. An exemplary application is a text editor to which the processor provides with received and/or processed input symbols. Any type of symbols may be applicable for association with keys of the keyboard 402 and the inventive input concept of the invention, such as letters, numbers, kanji, kana, strokes, etc. The processing of the input symbols may be of any kind, but in the present case, this disclosure is aimed at processing according to the input methods described with reference to FIGS. 1 and 2, which for the sake of conciseness is not described once more for the apparatus 400. However, it should be understood that the features described with reference to FIGS. 1 and 2 are applicable to the apparatus 400.

A memory 406 is connected to the processor 404. The memory 406 may be comprised in one or more units, and at least a part of it may be arranged remotely, for example as a server where a client-server structure is provided, where the apparatus 400 acts as a client. Thus, communication means (not shown) may be provided for the communication between the client and the server.

The apparatus 400 further comprises a display 408, which together with the keyboard 402 enables a user interface for the apparatus 400. The display 408 is arranged to display visual outputs from the processor 404. The display 408 can optionally be a touch sensitive display, which then also forms a part of the input means to the processor 404. This option enables that the keyboard 402 may be a virtual keyboard displayed on the display 408 which virtual keyboard is actuated by the operation of the touch sensitive display. The display 408 is further used for providing selectable word candidates, as disclosed with reference to FIGS. 1 and 2. This can be performed as illustrated in FIG. 8, which will be further described below. For the selection among the candidate words, the apparatus 400 can optionally be provided with navigation input means 410. Selection can alternatively be performed by displaying the candidates in a pattern that corresponds to the pattern of the keys of the keyboard 402, as illustrated in FIG. 9, wherein pressing the corresponding key will imply selection of the corresponding candidate word, as will be further described below. Another alternative is to use a touch sensitive display where selection is made by tapping the area where the desired word is displayed.

The processor 404 of the apparatus 400 is preferably loaded with one or more computer programs such that it or they can be executed to perform any of the methods described with reference to FIGS. 1 and 2. The processor 404 can be arranged to execute the program code sequentially where actions of the any of the methods are performed stepwise, or be arranged to execute the program code on a real-time basis where actions of any of the methods are performed upon need and availability of data. The processor 404 is preferably what normally is referred to as an embedded system in the apparatus 400, which can be a mobile telephone, a personal digital assistant, a digital camera, a media player, or a combined apparatus combining the features of any of a mobile telephone, a personal digital assistant, a digital camera, and a media player. The program code can be native software, i.e. specific software for the processor and apparatus, or a general software product loaded into the apparatus 400, e.g. via a communication network.

FIG. 5 illustrates an exemplary keyboard having keys uniquely associated to symbols. In this example, the two-type approach will give word candidates having a first and a second symbol associated with the first and second pressed keys upon overlap in time of pressing the keys. This gives a relatively limited set of candidates, but for some combinations of input, there can still be a considerable amount of candidates. In the latter case, it can be advantageous to process the candidate set to provide the most probable candidates, and further advantageous to provide the candidates in a ranked order according to their determined probability.

FIG. 6 illustrates an exemplary ambiguous keyboard. Here it can be noted that keys can be associated with two symbols. In this example, the two-type approach will give word candidates having a first and a second symbol that is associated with the symbols of the first and second pressed keys upon overlap in time of pressing the keys. This gives a larger set of candidates compared to the example described with reference to FIG. 5, and for some combinations of input, there can be a considerable amount of candidates. It can therefore be advantageous to process the candidate set to provide the most probable candidates, and further advantageous to provide the candidates in a ranked order according to their determined probability.

FIG. 7 illustrates another exemplary ambiguous keyboard. Here it can be noted that keys can be associated with four symbols. In this example, the two-type approach will give word candidates having a first and a second symbol that is associated with the symbols of the first and second pressed keys upon overlap in time of pressing the keys. This gives a quite large set of candidates, especially compared to the example described with reference to FIG. 5, but also compared to the example described with reference to FIG. 6, and for many combinations of input, there can be a considerable amount of candidates. Here it is especially advantageous to process the candidate set to provide the most probable candidates, and further advantageous to provide the candidates in a ranked order according to their determined probability.

FIG. 8 illustrates an exemplary apparatus 800 in which the invention is used. The apparatus 800 comprises a keyboard 802, a display 808, and a navigation input means 810. The apparatus 800 is for example a mobile phone. The keyboard 802 is an ambiguous keyboard where keys 803 are associated with several symbols, here exemplary illustrated with letters. Imagine that a user presses key “5” 805 and then key “6” 806 while still pressing key “5” 805. The apparatus 800 will then find candidate words 811 according to any of the methods described with reference to FIGS. 1 and 2 and display the candidate words 811 on the display 808. A marker 812 is provided on one of the candidates, and the marker can be moved between the candidate words 811 by the navigation means 810. Setting the marker 812 to the desired candidate word and pressing a select key 814 can select the desired candidate word. The selected word is then invoked into the used application, e.g. a text editor.

FIG. 9 illustrates an exemplary apparatus 900 in which the invention is used. The apparatus 900 comprises a keyboard 902 and a display 908. The apparatus 900 is for example a digital compact camera where text input is enabled to put notes to the captured images or videos. The keyboard 902 is an ambiguous keyboard where keys 903 are associated with several symbols, here exemplary illustrated with letters. Imagine that a user presses a first key 905 and then a second key 906 while still pressing the first key 905. The apparatus 900 will then find candidate words 911 according to any of the methods described with reference to FIGS. 1 and 2 and display the candidate words 911 on the display 908. The candidate words 911 are arranged in a configuration corresponding to the configuration of the keys 903. Pressing the key corresponding to the desired candidate word implies selection of the desired candidate word. The selected word is then invoked into the used application, e.g. a text editor.

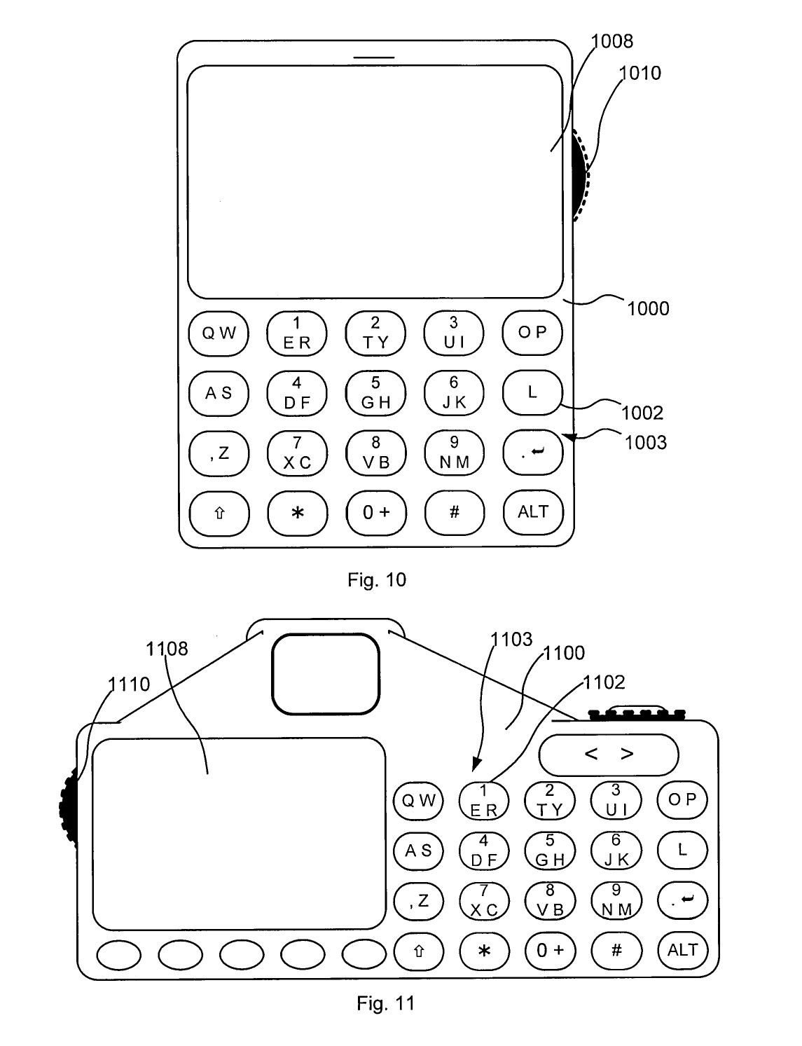

FIG. 10 illustrates an exemplary apparatus 1000 in which the invention is used. The apparatus 1000 comprises a keyboard 1002, a display 1008, and a navigation input means 1010. The apparatus 1000 is for example a personal digital assistant or a media player. The keyboard 1002 is an ambiguous keyboard where keys 1003 are associated with several symbols, here exemplary illustrated with letters. The display 1008 can be a touch sensitive display where selection can be performed by tapping the desired word.

FIG. 11 illustrates an exemplary apparatus 1100 in which the invention is used. The apparatus 1100 comprises a keyboard 1102, a display 1108, and a navigation input means 1110. The apparatus 1100 is for example a digital system camera or a video camera. The keyboard 1102 is an ambiguous keyboard where keys 1103 are associated with several symbols, here exemplary illustrated with letters. The display 1108 can be a touch sensitive display where selection can be performed by tapping the desired word.

In the above disclosure, the term “symbols” should be construed as elements for composing text, and may comprise letters, numbers, kanji, kana, strokes, logograms, characters, etc. whichever is used for different languages. Further, the term “word” should be construed as any unit of language, such as morpheme, phoneme, grapheme, semantic unit, expression, idiom, etc.

What I claim is:

1. A method for predictive text input comprising
receiving a first key typing on a first key, wherein said first key is associated with a first symbol or set of symbols;
receiving a second key typing on a second key while said first key is still pressed, wherein said second key is associated with a second symbol or set of symbols;
determining words from a word list beginning with said first symbol or any of the symbols of said first set of symbols and being followed by said second symbol or any of the symbols of said second set of symbols;
enabling selection among said determined words; and
upon selection, inputting said selected word.

2. The method according to claim 1, wherein said first and second set of symbols associated with said first and second keys, respectively, are forming an ambiguous keyboard.

3. The method according to claim 1, wherein said determining of words comprises
ranking probability of said words from a word list beginning with said first symbol or any of the symbols of said first set of symbols and being followed by said second symbol or any of the symbols of said second set of symbols; and
providing a presentation order of said determined words based on said ranking.

4. The method according to claim 3, wherein said probability ranking comprises determining frequency of said words for a selected language.

5. The method according to claim 3, wherein said probability ranking comprises determining frequency of said words in previous inputs.

6. An apparatus having text input capabilities comprising
a keyboard;
a processor adapted to receive and process input from said keyboard;
a memory arranged to be accessible by said processor and to hold a word list; and
a display which is controlled by said processor,
wherein said keyboard is enabled to receive a first key typing on a first key, wherein said first key is associated with a first symbol or set of symbols, and a second key typing on a second key while said first key is still pressed, wherein said second key is associated with a second symbol or set of symbols, said processor is arranged to determine words from said word list beginning with said first symbol or any of the symbols of said first set of symbols and being followed by said second symbol or any of the symbols of said second set of symbols, and said processor is further arranged to display said determined words on said display to enable selection among said determined words, and to receive a selection for input of a selected word.

7. The apparatus according to claim 6, wherein said keyboard is an ambiguous keyboard.

8. The apparatus according to claim 6, wherein said processor is further arranged to rank probability of said words from a word list beginning with said first symbol or any of the symbols of said first set of symbols and being followed by said second symbol or any of the symbols of said second set of symbols; and to provide a presentation order for said determined words based on said ranking.

9. The apparatus according to claim 8, wherein said memory holds a meta data field for said words in said word list indicating probability of its corresponding word.

10. The apparatus according to claim 9, wherein said meta data comprises relative frequency data of the word in its language, frequency data of the word in previous inputs, a weighting factor, or a grammar script, or any combination thereof.

11. A computer readable medium comprising program code, which when executed by a processor is arranged to cause the processor to perform
receiving a first key typing on a first key, wherein said first key is associated with a first symbol or set of symbols;
receiving a second key typing on a second key while said first key is still pressed, wherein said second key is associated with a second symbol or set of symbols;
determining words from a word list beginning with said first symbol or any of the symbols of said first set of symbols and being followed by said second symbol or any of the symbols of said second set of symbols;
enabling selection among said determined words; and
upon selection, inputting said selected word.

12. The medium according to claim 11, wherein the program code which when executed by a processor is further arranged to cause the processor to perform
ranking probability of said words from a word list beginning with said first symbol or any of the symbols of said first set of symbols and being followed by said second symbol or any of the symbols of said second set of symbols; and
providing a presentation order of said determined words based on said ranking.
